(19) United States
(12) Patent Application Publication
(10) Pub. No.: US 2007/0292124 A1
(43) Pub. Date: Dec. 20, 2007

(54) Camera

(76) Inventors: Frank Gottwald, Weissach (DE); Werner Knee, Esslingen (DE); Volker Uffenkamp, Ludwigsburg (DE); Jens Schick, Herrenberg (DE)

Correspondence Address: KENYON & KENYON LLP, ONE BROADWAY, NEW YORK, NY, 10004, US

(21) Appl. No.: 10/591,926

(22) PCT Filed: Jan. 14, 2005
(86) PCT No.: PCT/EP05/50150

§ 371 Date: Jun. 26, 2007

(30) Foreign Application Priority Data
Mar. 3, 2004 (DE) 10 2004 010 957.5

(51) Int. Cl. G03B 17/56

(52) U.S. Cl. 396/419

(57) ABSTRACT

A camera in particular for a motor vehicle having at least one image converting element. The image converting element includes at least one image sensor and is connected to at least one additional element of the camera, e.g., the housing of the camera, by at least one interlock.

### BACKGROUND INFORMATION

German Patent No. DE 40 32 927 describes a camera in a motor vehicle. This camera is used to improve visibility conditions and is therefore mounted in an area of the inside rear view mirror for detecting the viewing range of the driver in the direction of travel.

### SUMMARY OF THE INVENTION

The camera according to the present invention, in particular for a motor vehicle, has the advantage that a simple design of the camera is achieved with a high precision of the camera design at the same time. Furthermore, the camera has the advantage that the configuration is sturdy so the configuration is not sensitive to vibrations and temperature fluctuations. In addition, the camera is inexpensive to manufacture. Furthermore, the connection of the image converting element to another element of the camera through at least one interlock has the advantage that manufacturing tolerances in the components are easily compensatable by the interlock. This has the advantage that the precision requirements of the components are reduced and therefore the manufacturing costs of the components are low. In summary, the camera described below is particularly suitable for use in a motor vehicle such as a passenger car or a truck due to the achievable high precision, its sturdiness, and its inexpensive manufacture.

The interlock is a form-fitting connection which is established by solidification of an interlocking material, the elements which are to be joined remaining essentially unchanged in form and/or material properties. This yields the advantage that in contrast with an adhesion joint such as a glue joint, the connection is accomplished without stress. This results in a particularly high precision to be achievable in the design of the camera. Furthermore, a plurality of materials is available as the interlocking material, e.g., two-component epoxy materials, UV-crosslinking materials, materials based on plastic, or soldering tin.

It is also advantageous that the image converting element and/or the additional element of the camera includes at least one connecting element having an undercut, because then the interlock is particularly sturdy and long-lived. It is particularly advantageous for a connecting element to be designed in the shape of a cylinder and/or if the undercut is in the form of a countersunk head and/or a nail head because these designs are easily manufacturable and also ensure a secure connection by interlocking.

It is also particularly advantageous that the image converting element and/or the additional element of the camera includes at least one container because this contributes to a controlled introduction of the interlocking material during the manufacture of the camera. The interlocking material remains essentially limited to this container. Therefore, the risk of damage to or soiling of additional elements of the camera such as the optical elements is counteracted in an advantageous manner. Furthermore, the container has the advantage that only a small quantity of interlocking material, preferably 4 mm³ to 8 mm³, is required per interlocking operation. This also contributes to inexpensive manufacture of the camera.

It is advantageous that the interlocking material is solidified by ultraviolet radiation and/or the interlocking material includes at least two components that cooperate to cause the interlocking material to solidify and/or the interlocking material is solidified by cooling because interlocking materials having such properties are particularly suitable for manufacturing the camera because rapid hardening of the interlocking material is achieved and this contributes to a short processing time in the manufacture of the camera while such interlocking materials also ensure the long-term stability of the camera.

It is particularly advantageous that at least a portion of the surface of the image converting element and/or at least a portion of the surface of the additional element of the camera has elevations and/or depressions in the area of the interlock because elevations and/or depressions may be produced easily and inexpensively. It is particularly advantageous if the part of the inside surface of the housing that is used for interlocking has elevations and/or depressions. Alternatively or additionally, it is also advantageous if the part of the circuit board and/or the part of the circuit board frame that is used for interlocking has elevations and/or depressions. A stress-free connection is achieved by form-fitting without adhesion due to the distribution of the interlocking material in the cavity between the elevations and/or depressions.

A camera in which the image converting element and the additional element of the camera are additionally joined by an adhesive bond has the advantage that manufacturing the camera is simplified because the image converting element may be secured rapidly and reliably with the additional element of the camera by a fast-acting adhesive bond to then perform the permanent interlocking in a second method step. In addition, it is advantageous to use the adhesive bond for a permanent connection because the stability of the configuration of the camera for ongoing operation and the service life of the camera are additionally increased.

An extremely small distance between the image converting element and the additional element of the camera in the area of the interlock between 0.5 mm and 3.5 mm contributes in an advantageous manner to a particularly high stability of the configuration of the camera. Furthermore, this permits a particularly compact and thus space-saving configuration of the camera.

It is advantageous if the image converting element includes at least one image sensor and/or at least one circuit board and/or at least one circuit board frame. It is particularly advantageous here if the image converting element is connected to the at least one other element of the camera, e.g., the housing and/or the optical unit, by at least one interlock via the circuit board frame because this results in a particularly stable configuration of the camera which is therefore suitable for automotive engineering. Alternatively or additionally, the circuit board is connected directly to the at least one additional element of the camera, for example the housing and/or the optical unit, by at least one interlock, because a circuit board frame may then be omitted and the camera is compact, lightweight, and inexpensive.

### BRIEF DESCRIPTION OF THE DRAWINGS

FIG. 1 shows a cross section of the camera of the first exemplary embodiment.

FIG. 2 shows a perspective view of the camera of the first exemplary embodiment.

FIG. 3 shows a perspective view of the camera of the first exemplary embodiment.

FIG. 4 shows a schematic drawing of the camera of an additional exemplary embodiment.

### DETAILED DESCRIPTION

A camera, in particular for a motor vehicle, having at least one image converting element is provided. The image converting element includes at least one image sensor and is connected to at least one other element of the camera, e.g., the housing of the camera, by at least one interlock.

Cameras for automotive use must be very sturdy and at the same time very accurate on the one hand while on the other hand they must be inexpensive. It is conceivable to achieve a high precision through additional design complexity. Possible solutions to this problem include pins, stop edges, or high-precision tolerances. These solutions are associated with increased costs. These costs are necessary for the operation of assembly of the camera to achieve a high precision but are not essential for use of the camera and are simply carried over there.

In the camera of the preferred exemplary embodiment as described below, an interlocking material is used for joining a circuit board laminate composed of at least two circuit boards and a circuit board frame made of aluminum or a single circuit board having a circuit board frame made of aluminum. The front housing part of the camera contains reservoirs (containers) having posts. The posts are pins having a compressed tip like an exposed rivet, for example. The posts are thus connecting elements having an undercut. The circuit board frame includes four anchors which are immersed into the reservoirs. In the preferred exemplary embodiment, the anchors are like screws screwed into the circuit board frame. The property whereby both posts and anchors provide undercuts in the reservoir for interlocking material is important. The connection through the interlocking material does not come about by gluing but instead by blocking the post and anchor elements. The reservoirs preferably have a capacity of approximately 4 mm³ to 8 mm³ interlocking material depending on the achievable manufacturing precision of the reservoirs and the housing. Furthermore the capacity is adapted to the loads to be expected during operation of the camera.

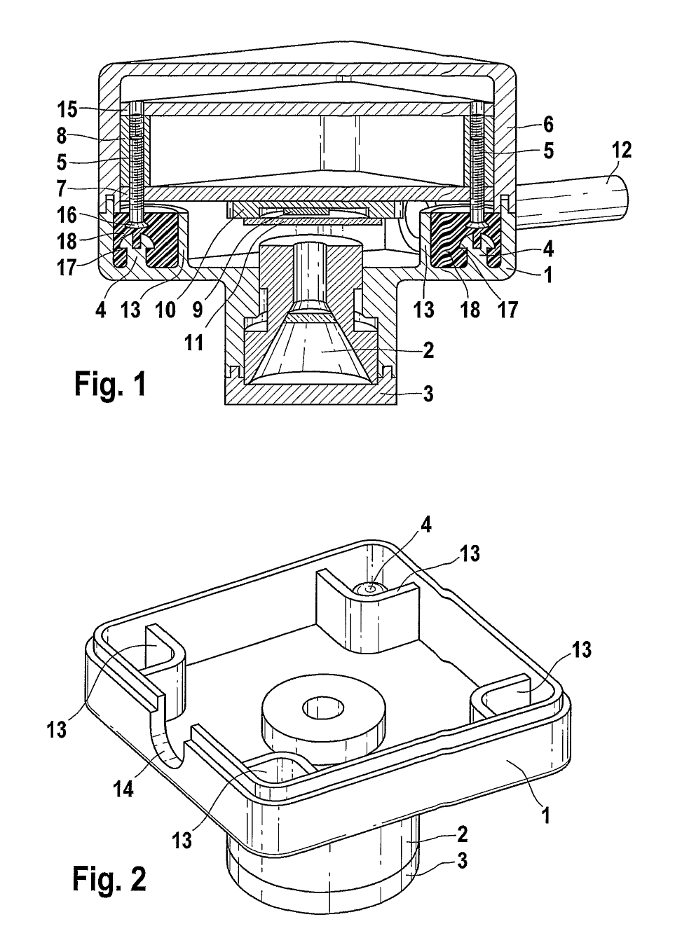

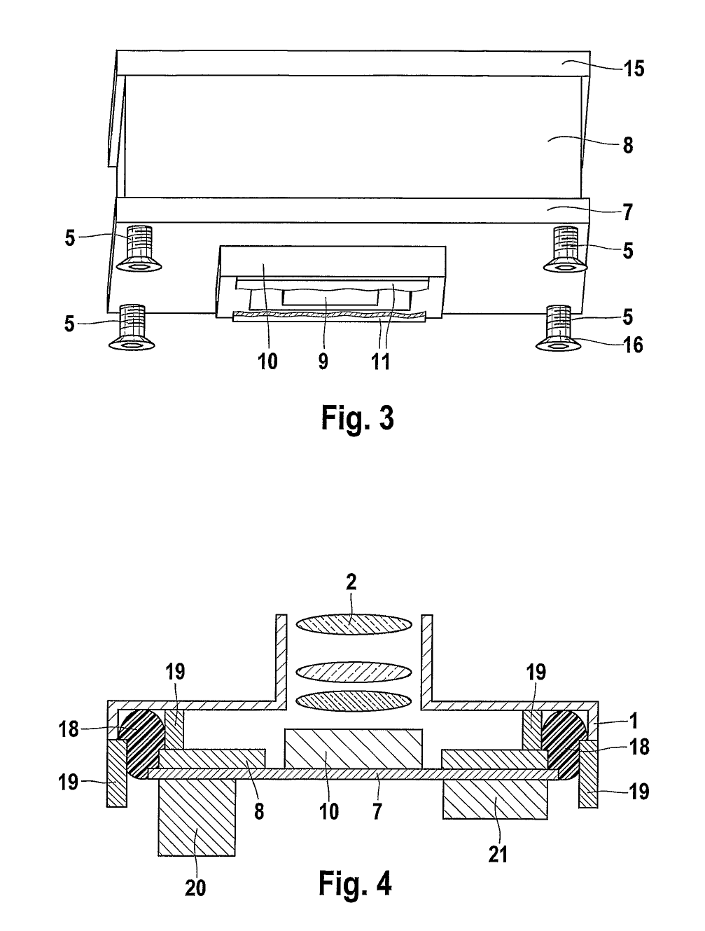

FIG. 1 shows a cross section of the camera of the preferred exemplary embodiment including a housing 1 and an image converting element. FIG. 2 shows a perspective view of housing 1 of the camera without the cover and the image converting element of the preferred exemplary embodiment, including four containers 13 here each having a post 4. FIG. 3 shows a perspective view of the image converting element of the camera of the first exemplary embodiment including a cuboid circuit board frame 8 and four anchors 5. With reference to FIGS. 1, 2 and 3, the design of the camera is described below. Housing 1 of the camera is an aluminum die cast part in the preferred exemplary embodiment and has an essentially rectangular base area and side faces that are on the base area and form a trough into the interior of the camera. Furthermore the base area of housing 1 has an outward facing protuberance in which optical unit 2 of the camera is situated. Optical unit 2 is covered toward the outside by an optical unit cover 3 which is removable during operation. In the interior of housing 1 there is a container 13 (reservoir) in each of the four corners of the base area. Each container 13 holds a post 4 situated essentially perpendicular to the base area of housing 1. Four posts 4 in the preferred exemplary embodiment are rivet-like bolts having an undercut 17. Undercut 17 is situated on the side facing away for fastening the bolt on housing 1. A cable opening 14 is provided in a side wall of housing 1, a plug on a cable 12 being passed through the cable opening through housing 1 and cover 6 to the outside. Cable 12 is sealed with respect to cable opening 14. Furthermore, FIG. 1 shows the image converting element which includes a processing circuit board 15, a circuit board frame 8, an image sensor circuit board 7, anchors 5 and an image sensor 10 including image sensor chip 9 and a glass cover 11 (glass lid). Processing circuit board 15 and image sensor circuit board 7 are connected to one another essentially in parallel via circuit board frame 8. Image sensor 10 is mounted on the side of image sensor circuit board 7 facing outward so that image sensor chip 9 together with optical unit 2 forms an optical system. Image sensor 10 is formed by image sensor chip 9 which is covered by a glass lid 11 to optical unit 2. The electronics for processing and transmission of the image information thus generated are provided on circuit boards 7, 15. Four anchors 5 are situated essentially perpendicularly to image sensor circuit board 7 on the side of image sensor 10 in each corner of circuit board frame 8 which is made of aluminum. In the preferred exemplary embodiment, anchors 5 are formed by countersunk head screws that are screwed into circuit board frame 8. Alternatively or additionally, the anchors 5 are directly molded on circuit board frame 8. Undercut 6 which may be designed in any way is the deciding element of anchors 5. In the preferred exemplary embodiment, undercut 16 is formed by the head of countersunk head screws. Alternatively or additionally, other cross sections in addition to conical cross sections of undercuts 16, 17 or posts 4 and anchors 5 are also used. Circuit board frame 8 is connected to housing 1 in such a way that one anchor 5 is immersed into a container 13 except for a distance of 0.5 mm to 3.5 mm from post 4 in container 13, the container being filled with interlocking material 18 so that the image converting element is interlocked with housing 1 as another element of the camera. In the preferred exemplary embodiment, a UV crosslinking interlocking material 18 is used for interlocking. Therefore, UV crosslinking interlocking material 18 is cast in a liquid state into the four containers 13 after posts 4 and anchors 5 have been placed next to each other accordingly. Interlocking material 18 is then cured with ultraviolet radiation (UV radiation) to activate the interlock. In the preferred exemplary embodiment, the projection surfaces of a post 4 on the end face and a particular anchor 5 overlap at least 60% with each individual interlock. A cover 6 which is also pan-shaped seals the interior of the camera in combination with trough-shaped housing 1 with respect to the outside.

FIG. 4 shows a schematic drawing of the camera of the additional exemplary embodiment, including a housing 1 and an image converting element. Again in this additional exemplary embodiment, the camera includes an optical unit 2 and an image sensor 10, which is positioned precisely in relation to this optical unit 2. Image sensor 10 is attached to an image sensor circuit board 7, image sensor 10 containing an image sensor chip, i.e., the photosensitive silicon, in the housing of image sensor 10 and a transparent protective cover. No special requirements are necessary regarding the dimensional precision of the image sensor chip in relation to the protective cover and to the electric terminals on the bottom of image sensor 10 or the position on image sensor circuit board 7. Furthermore, electronics 21 such as the electronic analyzer and a bushing 20 for the data and power by which image sensor circuit board 7 is triggered are situated on image sensor circuit board 7. Furthermore, a circuit board frame is mounted on image sensor circuit board 7 and in this exemplary embodiment is connected to housing 1. Elevations 19 and/or depressions are formed in housing 1 and/or in circuit board frame 8. In this additional exemplary embodiment, elevations 19 are provided in both housing 1 and also in frame 8. In this exemplary embodiment, the hollow space between housing 1 and circuit board frame 8 is at least partially filled with a hardening filler material as interlocking material 18. The amount and/or filling technique is selected so that interlocking material 18 does not come between optical unit 2 and image sensor 10 and/or in the case of a conducting interlocking material 18, it does not get on image sensor circuit board 7. During the nonshrinking hardening of interlocking material 18, circuit board frame 8 and/or image sensor 10 is connected to housing 1 and/or to optical unit 2 without stress. Since the filler material is distributed between elevations 19 and/or the depressions in the hollow space, housing 1 and circuit board frame 8 are joined together without stress by the form-fitting connection alone without any adhesion.

In one variant of the exemplary embodiments described here, as an alternative or in addition to the interlocking material which is solidified by UV radiation, an interlocking material that is solidifiable by cooling and/or an interlocking material composed of two components solidified by combining the two components is also used. The interlocking material preferably has at least one of the following properties: it solidifies rapidly, e.g., between 10 seconds and 30 seconds, and/or it solidifies homogeneously and/or it has low shrinkage in solidification and/or it has no interaction with other materials, i.e., is chemically inert and/or it does not outgas and/or it has a low thermal expansion coefficient.

In another variant of the preferred exemplary embodiment, the image sensor and/or the image sensor circuit board and/or the processing circuit board and/or the circuit board frame of the image converting element is connected to at least one other element of the camera, e.g., the housing of the camera and/or the optical unit of the camera and/or the cover of the camera by at least one interlock.

According to another variant, in addition to interlocking, the image converting element and the at least one additional element of the camera are additionally joined by an adhesive joint, the adhesive joint preferably being situated in the area of the at least one interlock.

1-11. (canceled)

12. A camera comprising:
at least one image converting element;
at least one additional element; and
at least one interlock for connecting the image converting element to the at least one additional element.

13. The camera according to claim 12, wherein the interlock is a form-fitting connection, the connection being established by solidification of an interlocking material.

14. The camera according to claim 12, wherein at least one of the image converting element and the additional element includes at least one connecting element having an undercut, the connecting element being a component of the interlock.

15. The camera according to claim 14, wherein the connecting element is designed as a cylinder and the undercut is designed in at least one of a countersunk-head-like and nail-head-like manner.

16. The camera according to claim 12, wherein at least one of the image converting element and the additional element includes at least one container, the container accommodating at least one of (a) at least an interlocking material and (b) at least a connecting element having an undercut, the container having a capacity of 4 mm³ to 8 mm³ of interlocking material.

17. The camera according to claim 13, wherein at least one of (a) the interlocking material is solidified by ultraviolet radiation, (b) the interlocking material includes at least two components which cooperate to cause the interlocking material to solidify, and (c) the interlocking material is solidified by cooling.

18. The camera according to claim 12, wherein at least one of the image converting element and the additional element includes means for ensuring an interlock, having at least one of elevations and depressions in that at least part of a surface of at least one of the image converting element and the additional element has at least one of elevations and depressions in an area of the interlock.

19. The camera according to claim 12, wherein the image converting element and the additional element are additionally connected by an adhesive bond, the adhesive bond being in an area of an interlock.

20. The camera according to claim 12, wherein a smallest distance between the image converting element and the additional element in an area of an interlock is between 0.5 mm and 3.5 mm.

21. The camera according to claim 12, wherein the image converting element includes at least one of (a) at least one image sensor, (b) at least one circuit board and (c) at least one circuit board frame.

22. The camera according to claim 12, wherein the at least one additional element includes at least one of a housing and an optical element.

23. The camera according to claim 12, wherein the camera is for a motor vehicle.
